(19) United States
(12) Patent Application Publication
(10) Pub. No.: US 2012/0243413 A1
(43) Pub. Date: Sep. 27, 2012

(54) Data Packet Priority Level Management

(75) Inventor: Sylviane Roullier, Le Mans (FR)

(73) Assignee: ST-ERICSSON SA, Plan-les-Ouates (CH)

(21) Appl. No.: 13/511,254

(22) PCT Filed: Nov. 12, 2010
(86) PCT No.: PCT/EP10/67395

§ 371 Date: May 22, 2012

(30) Foreign Application Priority Data
Nov. 25, 2009 (FR) 0958369

(51) Int. Cl. H04W 28/14; H04L 12/26

(52) U.S. Cl. 370/235

(57) ABSTRACT

The invention relates to the management of priority levels for data packets in a stream. In particular, the size of a data packet is determined for use in determining a priority level for said packet. Then the priority level for the data packet is determined based on the size of the data packet and the data packet is placed in a queue among a plurality of queues based on the priority level of the data packet, each queue being associated with a priority level.

### TECHNICAL FIELD

This invention relates to the management of the data packet priority level in a stream of such packets. In particular, it concerns the management of the quality of service for data transmissions through a mobile terminal acting as a modem, such as a mobile telephone, a third generation (3G) USB modem or an internal modem for a personal computer.

### TECHNOLOGICAL BACKGROUND

Today's usage of a mobile terminal, for example a 3G mobile telephone, often includes connecting it to a personal computer such as a laptop in order to access the Internet or various data services. The mobile terminal then acts as a modem used to establish a data link. The user can then benefit from the many services offered by a variety of applications on the computer, such as IP telephony, messaging, the web, streaming multimedia, etc. The data associated with each of these services shares the same data link. Time constraints on the data from different services vary widely, however. It is therefore desirable to have a mechanism for managing priority levels for application data on the same data link.

There are various known solutions to this problem. Certain radio protocols also provide a means of quality of service management. These solutions require the use of specific protocols, or control by a specific application. Management of the quality of service by these known solutions must therefore be arranged beforehand. However, such solutions cannot be used when no modification to the radio or application protocol is desired or possible. This is the case when the data received by the mobile terminal contain no radio or application protocol information specifying the corresponding priority level for said data. Similarly, data from an application which doesn't manage the quality of service cannot be sent in an order which is a function of their priority level.

There are also deep packet analysis techniques, commonly called DPI for Deep Packet Inspection, used by certain routers to manage quality of service. These techniques consist primarily of analyzing the content of the application data in order to determine a corresponding priority level. However, the computing power needed to implement such analysis techniques is significant and is unavailable on the mobile terminals in discussion here.

A need therefore exists for a solution, adapted for terminals having limited computing power, for managing the quality of service on a data link for data that have no priority information.

### SUMMARY OF THE INVENTION

A first aspect of the invention proposes a method for determining a priority level for a data packet. The size of the data packet is determined. The priority level for the data packet is determined as a function of the size of the data packet.

Packets processed in this manner initially have no specific information regarding the corresponding priority level. It has been observed, however, that applications subject to strong time constraints generally use smaller packets for communicating data than those used by applications with weaker time constraints. The method proposes assigning a priority level to a packet, based only on knowledge of the packet size. The method does not need to see the contents of the data encapsulated in the packet to determine the priority level, unlike deep packet inspection techniques. The computing power required to implement the method is therefore particularly low.

To meet other requirements, because the data packet is composed of a plurality of protocol data units, the size of the data packet is determined by adding the size of each protocol data unit in the packet.

In one embodiment, the priority level of the data packet can be obtained by:
determining whether the packet size satisfies at least one determined criterion,
selecting, from a list of priority levels, the priority level corresponding to:
   the criterion satisfied, or
   a default level if no criterion is satisfied, and
placing the data packet in a queue among a plurality of queues based on the priority level of the data packet, each queue being associated with a priority level.

In particular, the list of priority levels can comprise a high priority level and a standard priority level, with the standard priority level being the default level. The criterion corresponding to the high priority level is, for example, “less than or equal to X bytes” where X is an integer.

In a second aspect, a method for sending data packets is proposed in which:
a priority level is determined for each data packet by using the method according to the first aspect,
the data packets are sent in an order defined according to the priority level of the data packets.

Priority packets, meaning those for which the priority level is higher than the other packets, are given priority over packets with a lower priority level. The user experience is improved because the applications that are more demanding in terms of latency and transmission times will see their data transmission performance increase, even if said applications contain no mechanism for managing the quality of service.

In a third aspect, a method for receiving data packets is proposed in which:
a priority level is determined for each data packet by applying the method according to the first aspect,
if one or more data packets are incomplete, the priority level for the complete packets is compared to at least one threshold,
the complete packets having a priority level greater than the threshold are transmitted.

Data packets are generally sent in an order in a packet sequence. Each packet consists of a plurality of protocol data units, generally referred to as PDU for Protocol Data Units. Communication networks are generally configured so that, in radio link protocols, a packet in the sequence cannot be delivered until all preceding packets in the sequence have been received in their entirety, meaning all protocol data units composing each packet have been fully received. This introduces a delay in delivering certain complete packets, because even if all their protocol data units are received, they cannot be delivered if even one protocol data unit in a previous packet in the sequence has not been received. This poses a particular problem for higher priority packets. Through the method of the third aspect of the invention, complete priority packets are delivered if their priority level is sufficiently high. Thus, even if other packets in the sequence are incomplete, these priority packets can be routed without delay.

A fourth aspect of the invention proposes a module for determining the priority level of a data packet. It comprises a means for determining a size of the data packet. It comprises a calculation means for determining the priority level of the data packet based on the size of the data packet. The module is adapted to place the data packet in a queue among a plurality of queues based on the priority level of the data packet, each queue being associated with a priority level.

As the data packet is composed of a plurality of protocol data units, the means for determining the size of the data packet can be configured to calculate the size of the data packet by adding the size of each protocol data unit composing the packet.

The calculation means can be adapted to determine the priority level of the data packet by:
determining whether the size of the data packet satisfies at least one determined criterion, and
selecting, from a list of priority levels, the priority level corresponding to:
   the satisfied criterion, or
   a default level if no criterion is satisfied.

The list of priority levels comprises, for example, a high priority level and a standard priority level, with the standard priority level being the default level. The criterion corresponding to the high priority level is then “less than or equal to X bytes” for example, where X is an integer.

A fifth aspect of the invention proposes a portable electronic device comprising a module according to the fourth aspect. The portable electronic device can be adapted to implement the method of the second aspect in order to send data packets for a third party connected to a remote network. The portable electronic equipment can also be adapted to implement the method of the third aspect in order to receive data packets for a third party connected to a remote network.

A sixth and final aspect of the invention proposes a system comprising a device according to the fifth aspect, and a computer. The device and the computer can be coupled together by a local link. The device is configured to act as an interface between the computer and the remote network.

### BRIEF DESCRIPTION OF DRAWINGS

Other features and advantages of the invention will become apparent from reading the following description. This description is purely illustrative and is to be read while referring to the attached drawings, in which:

FIG. 1 is a schematic diagram of a system comprising a mobile terminal and a computer,

FIG. 2 is a block diagram of an embodiment of a method for determining a priority level,

FIG. 3 is a block diagram of an embodiment of a method for sending data packets,

FIG. 4 is a block diagram of an embodiment of a method for receiving data packets,

FIG. 5 is a diagram of an embodiment of a method implemented in a mobile terminal.

### DESCRIPTION OF AN EMBODIMENT

In the drawings, identical reference numbers indicate identical elements in the different figures.

The following description, which is provided for illustrative purposes only, considers a system comprising a mobile terminal 10 and a computer 12, on which runs an application A, an application B, and an application C, as represented in FIG. 1. The mobile terminal 10 is adapted to establish a data link 14 to a remote network 16. The mobile terminal 10 and the computer 12 are coupled by a local link 18. The mobile terminal 10 is configured to act as an interface between the computer 12 and the remote network 16. More particularly, the mobile terminal 10 acts as a modem for the computer 14. Thus the applications A, B and C can receive data originating from the remote network 16 or send data to the remote network 16. The data exchanged over the data link 14 are encapsulated in packets, using the Internet Protocol for example.

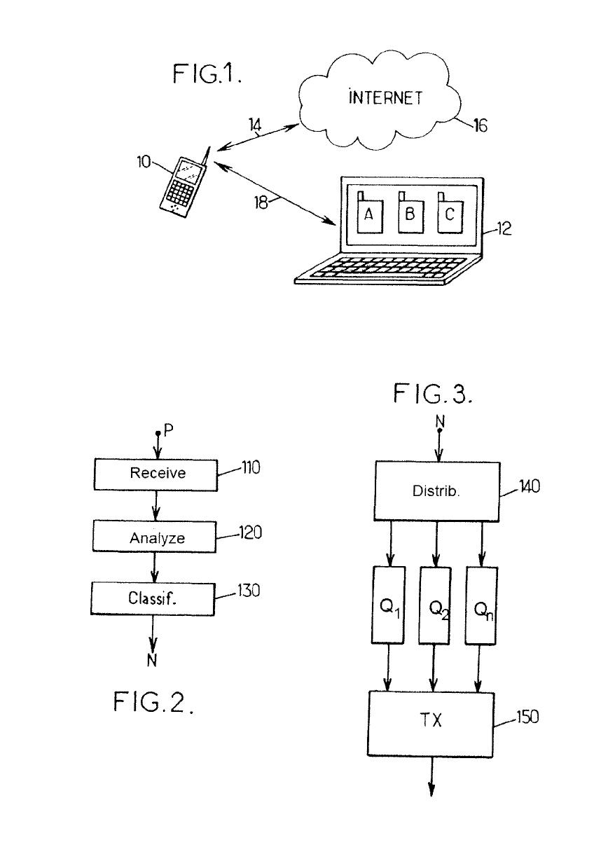

In one embodiment, represented in FIG. 2, the method for determining a priority level comprises a first step 110 during which a packet P₁ is received. Typically, the data packet P₁ consists of a plurality of protocol data units, generally referred to by the acronym PDU. In the radio link protocol, the plurality of received protocol data units is assembled to form the data packet P₁.

Then in a second step 120, the size of the packet P₁ is determined. The size of the packet P₁ can be calculated when assembling the protocol data units to form the packet P₁. For example, the size of the packet P1 is obtained by adding the size of each protocol data unit composing the packet P₁.

In a third step 130, a priority level N for the packet P₁ is determined based on the size determined during the second step 120, and on at least one criterion C₁. For example, a priority level N is chosen from a list comprising a first high level and a second standard level. The first criterion C₁ is then “less than or equal to X bytes” where X is an integer of a value which is, for example, equal to 160. In this example, if the size of the packet P₁ satisfies the criterion C₁, meaning if the size of the packet P₁ is less than or equal to X bytes, then the priority level for the packet P₁ is equal to the first high level. If the size of the packet P₁ does not satisfy the criterion C1, meaning the size of the packet P₁ is greater than X bytes, then the priority level for the packet P₁ is equal to the default level, which is the second standard level. A plurality of criteria and priority levels can of course be employed, in order to refine the management of the priority levels, for example.

Optional steps for sending data packets in one embodiment are illustrated in FIG. 3. After determining the priority level N for the packet P₁ during the third step 130, the packet P₁ is placed during a fourth step 140 in a queue among a plurality of queues Q₁, Q₂, . . . , Qₙ, based on the priority level N of the packet P₁. For example, if during the third step 130, an integer n of distinct priority levels N are distinguished, a separate queue Q is associated with each of the n priority levels N. The queue Q₁ corresponds for example to a first priority level, the queue Q₂ to a second priority level, and the queue Qₙ to an n^{th} priority level. The first priority level corresponds, for example, to the highest priority level, the second priority level to a priority level that is lower than the first priority level, and the n^{th} priority level to the lowest priority level.

Upon receipt of a new packet during the first step 110, the second, third, and fourth step are repeated. In this manner the different packets P₁ received are distributed among the plurality of queues Q₁, Q₂, . . . , Qₙ.

In parallel to the first, second, third, and fourth step, a fifth step 150 is executed, during which the packets P₁ comprised in the plurality of queues Q₁, Q₂, . . . , Qₙ are sent according to their priority level N. For example, the packets comprised in queue Q₁ will be sent with a higher priority than all packets comprised in the other queues, while the packets comprised in the queue Qₙ will be sent with a low priority, typically after all packets in the other queues have been sent or after a timer has been exceeded.

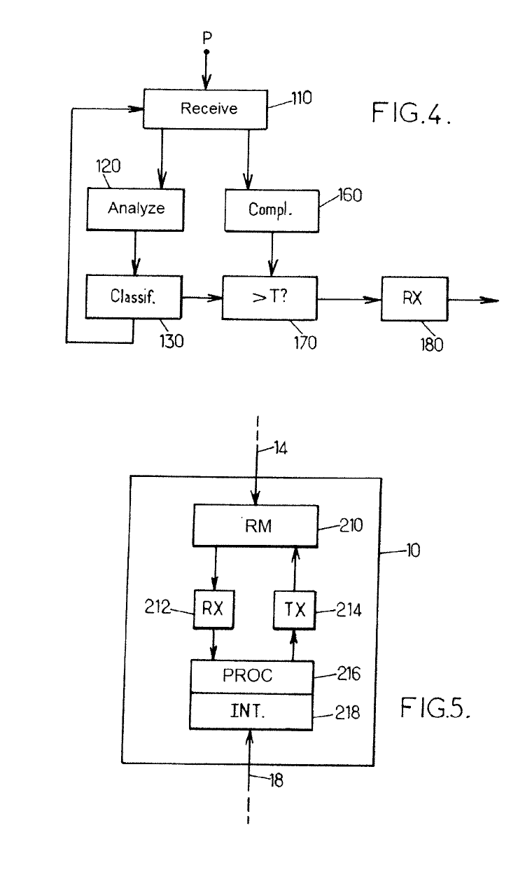

Optional steps for receiving data packets according to an embodiment are illustrated in FIG. 4. An integer a of packets P₁, . . . , Pₐ are received during the first step 110. For each packet P₁, . . . , Pₐ received, a priority level N₁, Nₙ is determined by applying the second step 120 and the third step 130. Alternatively, a priority level N₁, . . . , Nₙ is determined by applying the second step 120 and the third step 130 for only the complete packets P₁, . . . , Pₐ.

In parallel to the first, second, and third step, a sixth step 160 identifies whether one or more packets among the packets P₁, . . . , Pₐ are incomplete. Incomplete is understood to mean a packet in which at least one protocol data unit has not been received within a given time period.

Then, if incomplete packets have been identified during the sixth step 160, the priority level N₁, . . . , Nₐ of the complete packets is compared to at least one threshold T during a seventh step 170. All complete packets for which the priority level N₁, . . . , Nₐ is greater than or equal to the threshold T are selected. In this manner the packets having the higher priority levels are selected. Complete is understood to mean a packet in which all the protocol data units composing said packet have been received within a given time period.

During an eighth step 180, the complete packets selected during the seventh step 170 are transmitted to the recipient, meaning the packets having a priority level above the threshold T and therefore the highest priority packets, even if incomplete packets were received among the packets P₁, . . . , Pₐ.

As is represented in FIG. 5, the mobile terminal according to one embodiment comprises a radio module 210, a data receiving module 212, a data transmission module 214, a processing unit 216, and an interface module 218. The data receiving module 212, the data transmission module 214, and the processing unit 216 can be implemented within the same component. The radio module 210 allows accessing the radio channel supporting the data link 14. Typically, the radio module 210 provides access to the physical channels of a third generation mobile telephony system supporting data transfers. The interface module 218 allows establishing a local connection 18 to the computer 12. The local connection 18 can be a wired connection such as USB (Universal Serial Bus), or a wireless connection such as Bluetooth. The processing unit 216 is typically a microprocessor for executing an operating system and/or firmware.

The receiving module 212 typically processes data sent by a third party connected to the remote network 16 and intended for an application running on the computer 12. The receiving module 212 is adapted to implement the priority management method described above, particularly the optional receiving steps.

The transmission module 214 typically processes the data from an application running on the computer 12 to be sent to a third party connected to the remote network 16. The transmission module 214 is adapted to implement the priority management method described above, particularly the optional transmission steps.

This invention can be implemented by hardware means, software means, or a combination of hardware and software means. Any processors, controllers, or other devices adapted to implement the functionalities described here are appropriate.

A typical combination of software and hardware means can include a general purpose microprocessor (or a controller) associated with a computer program, which when the program is loaded and executed, implements the functionalities described here.

The invention can also be included in a computer program which comprises all the characteristics for implementing the described methods and which, when loaded into an information processing system, is able to implement these methods.

Such a computer program can be stored on a computer, or on a machine-readable medium allowing data, instructions, messages or message packets, and other information which can be read by a machine, to be read from the medium. The machine-readable medium can include non-volatile memory such as read-only memory (ROM), flash memory, a hard drive, a CD-ROM, and other permanent storage media. A computer-readable medium can also include, for example, a volatile storage medium such as random access memory (RAM), buffers, cache memory, and network circuits. In addition, the machine-readable medium can comprise information on a medium in a transient state, such as a network connection, and/or a network interface, comprising a wired or wireless network, allowing a device to read such information.

Although specific embodiments of the invention have been described above for illustrative purposes, it is understood that various modifications can be made without leaving the scope of the invention.

In addition, the reference labels in the claims do not limit the scope of the claims in any way. They were introduced primarily to improve the readability of the claims.

1.-14. (canceled)

15. A method of determining a priority level for a data packet, comprising:
determining a size of the data packet,
determining the priority level for the data packet based on the size of the data packet, and
placing the data packet in a queue among a plurality of queues based on the priority level of the data packet, each queue being associated with a respective priority level.

16. The method of claim 15, wherein determining the priority level of the data packet includes:
determining whether the size of the data packet satisfies at least one determined criterion, and
selecting from a list of priority levels the priority level corresponding to either a satisfied criterion or, if no criterion is satisfied, a default priority level.

17. The method according to claim 16, wherein the list of priority levels comprises a high priority level and a standard priority level, the standard priority level is the default priority level, and the high priority level corresponds to a criterion “less than or equal to X bytes”, where X is an integer.

18. The method of claim 15, wherein the data packet includes a plurality of protocol data units, and determining the size of the data packet includes adding a size of each protocol data unit included in the data packet.

19. The method of claims 18, wherein determining the priority level of the data packet includes:
determining whether the size of the data packet satisfies at least one determined criterion, and
selecting from a list of priority levels the priority level corresponding to either a satisfied criterion or, if no criterion is satisfied, a default priority level.

20. The method according to claim 19, wherein the list of priority levels comprises a high priority level and a standard priority level, the standard priority level is the default priority level, and the high priority level corresponds to a criterion “less than or equal to X bytes”, where X is an integer.

21. A method of sending data packets, comprising:
determining a priority level for each data packet by the method of claim 15, and
sending the data packets in an order defined according to the priority levels of the data packets.

22. A method of receiving data packets, comprising:
determining a priority level for each data packet by the method of claim 15,
if one or more data packets are incomplete, comparing priority levels of complete packets to at least one threshold, and
transmitting complete packets having a priority level greater than the at least one threshold.

23. A module for determining a priority level of a data packet, comprising:
first means for determining a size of the data packet, and
second means for determining the priority level of the data packet based on the size of the data packet;
wherein the module is adapted to place the data packet in a queue among a plurality of queues based on the priority level of the data packet, each queue being associated with a respective priority level.

24. The module of claim 23, wherein the second means determines the priority level by at least:
determining whether the size of the data packet satisfies at least one determined criterion, and
selecting, from a list of priority levels, a priority level corresponding to either a satisfied criterion, or if no criterion is satisfied, a default priority level.

25. The module of claim 24, wherein the list of priority levels comprises a high priority level and a standard priority level, the standard priority level is the default priority level, and the high priority level corresponds to a criterion “less than or equal to X bytes”, where X is an integer.

26. The module of claim 23, wherein the data packet includes a plurality of protocol data units, and the first means determines the size by at least adding a size of each protocol data unit included in the data packet.

27. The module of claims 26, wherein the second means determines the priority level by at least:
determining whether the size of the data packet satisfies at least one determined criterion, and
selecting, from a list of priority levels, a priority level corresponding to either a satisfied criterion, or if no criterion is satisfied, a default priority level.

28. The module of claim 27, wherein the list of priority levels comprises a high priority level and a standard priority level, the standard priority level is the default priority level, and the high priority level corresponds to a criterion “less than or equal to X bytes”, where X is an integer.

29. The module of claim 23, wherein the module is included in a portable electronic device.

30. The module of claim 29, wherein the portable electronic device is adapted to send data packets to a third party connected to a remote network by at least determining a priority level for each data packet and sending the data packets in an order defined according to the priority levels of the data packets; and the priority level for each data packet is determined by at least:
determining a size of the data packet,
determining the priority level for the data packet based on the size of the data packet, and
placing the data packet in a queue among a plurality of queues based on the priority level of the data packet, each queue being associated with a respective priority level.

31. The module of claim 29, wherein the portable electronic device is adapted to receive data packets from a third party connected to a remote network by at least determining a priority level for each data packet; if one or more data packets are incomplete, comparing priority levels of complete packets to at least one threshold; and transmitting complete packets having a priority level greater than the at least one threshold; and the priority level for each data packet is determined by at least:
determining a size of the data packet,
determining the priority level for the data packet based on the size of the data packet, and
placing the data packet in a queue among a plurality of queues based on the priority level of the data packet, each queue being associated with a respective priority level.

32. A system, comprising a module and a portable electronic device as in claim 29, and a computer, wherein the portable electronic device and the computer are configured for coupling by a local link, and the portable electronic device is configured as an interface between the computer and a remote network.
